(19) United States
(12) Patent Application Publication
(10) Pub. No.: US 2017/0140396 A1
(43) Pub. Date: May 18, 2017

(54) DEVICES, SYSTEMS, AND METHODS FOR OBTAINING HISTORICAL UTILITY CONSUMPTION DATA

(71) Applicants: Martha Amram, Mountain View, CA (US); Sandra Carrico, Mountain View, CA (US); Brian Ward, San Mateo, CA (US); David Nelson, San Francisco, CA (US); Trista Chen, San Francisco, CA (US); David Smith, Mountain View, CA (US)

(72) Inventors: Martha Amram, Mountain View, CA (US); Sandra Carrico, Mountain View, CA (US); Brian Ward, San Mateo, CA (US); David Nelson, San Francisco, CA (US); Trista Chen, San Francisco, CA (US); David Smith, Mountain View, CA (US)

(73) Assignee: Ennovationz, Inc., Mountain View, CA (US)

(21) Appl. No.: 15/353,479

(22) Filed: Nov. 16, 2016

Related U.S. Application Data
(60) Provisional application No. 62/255,986, filed on Nov. 16, 2015.

(51) Int. Cl. G06Q 30/02; G06Q 50/06

(52) U.S. Cl. CPC G06Q 30/0201; G06Q 50/06

(57) ABSTRACT

A computer-implemented method for identifying utility usage from a historical utility file is disclosed. The method includes obtaining a file containing historical utility consumption of a dwelling over a time period; processing the file through optical character recognition (OCR); identifying contextual data from the OCR processed file; identifying chart data from the OCR processed file; extracting one or more values from the chart data, wherein the values correspond to one or more elements of the chart data; and contextualizing the extracted values from the chart data by applying the contextual data to the extracted value to obtain utility usage data.

### CROSS-REFERENCES TO RELATED APPLICATIONS

This application claims the benefit and priority of U.S. Provisional Patent Application No. 62/255,986, entitled “DEVICES, SYSTEMS, AND METHODS FOR OBTAINING HISTORICAL UTILITY CONSUMPTION DATA”, filed on Nov. 16, 2015, the full disclosure of the above referenced application is incorporated herein by reference.

### BACKGROUND

Field of the Disclosure

The present disclosure relates generally to analyzing a historical utility consumption data to generate an itemized utility consumption profile by attributing utility consumption to seasonal utility consumption or non-seasonal utility consumption.

Description of the Related Art

With the growing awareness of global warming, climate change, and rising energy costs, consumers and industry increasingly demand greater efficiency in utility consumption. Recently, efforts have been made to activate the residential sector in improving utility consumption efficiency, as the residential sector accounts for 37% of annual electric sales and 21% of natural gas sales. Thus, improving residential utility consumption efficiency may affect energy consumption in a geographic region and lead to monetary savings for the consumers.

However, the residential sector has long been considered the hardest to reach for catalyzing consumption efficiency savings. Some of the barriers to consumer adoption, include lack of information, lack of connection to specific opportunities in the dwelling, and lack of clarity about benefits.

Particularly, one challenge of adoption of clean energy and identification of potential consumption savings is the lack of information, especially historical utility consumption data. To overcome the barriers, it would be desirable to provide a novel method to effectively obtain historical utility consumption data of a dwelling with sufficient resolution in order to obtain an understanding of the utility consumption of the dwelling.

### SUMMARY OF THE INVENTION

In some aspects, the present disclosure provides for the devices, systems, and methods for obtaining historical utility consumption data.

In one aspect, A computer-implemented method for identifying utility usage from a historical utility file, comprising obtaining a file containing historical utility consumption of a dwelling over a time period; identifying contextual data from the file; registering chart data from the file; extracting one or more values from the chart data, wherein the values correspond to one or more elements of the chart data; and contextualizing the extracted values from the chart data by applying the contextual data to the extracted value to obtain utility usage data.

In one aspect, the method further comprises processing the file through optical character recognition (OCR).

In one aspect, the chart data is a bar chart and the element of the chart data is a bar of the bar chart and wherein the contextual data comprises labelling of the x-axis and y-axis. In yet another aspect, the utility usage data are the kWh used as indicated by the bar of the bar chart.

In one aspect, the chart data is a pie chart and the element of the chart data is a portion of the pie chart.

In one aspect, the utility is electricity and the historical utility file is an electricity bill. In one aspect, the contextual data comprises identity of the utility provider.

Other aspects and variations are presented in the detailed description as follows.

### BRIEF DESCRIPTION OF THE DRAWINGS

embodiments have other advantages and features which will be more readily apparent from the following detailed description and the appended claims, when taken in conjunction with the accompanying drawings, in which:

FIG. 1 is a flow diagram illustrating one embodiment of calculating savings based on a historical utility consumption data file.

FIG. 2 shows an exemplary method for registering an image of a utility bill.

FIG. 3 depicts an alternative embodiment of method for registering an image of a utility bill.

FIG. 4 depicts an exemplary template.

FIG. 5 shows an exemplary embodiment of determining an loading a template configuration.

FIG. 6 shows an exemplary embodiment of calculating feature points of a template.

FIG. 7 shows an exemplary embodiment of determining an image type.

FIG. 8 shows an exemplary embodiment of determining feature points of an image.

FIG. 9 shows an exemplary embodiment of aligning feature points of a template with corresponding feature points of an image.

FIG. 10 shows an exemplary embodiment of processing an image using a transformation matrix.

FIG. 11 shows an exemplary embodiment of rasterizing an image.

FIG. 12 shows an exemplary embodiment of aligning feature points of a template with corresponding feature points of an image.

FIG. 13 shows an exemplary embodiment of processing an image using a transformation matrix to create a rectified chart area.

FIG. 14 depicts an embodiment of a method of reading a utility bill chart.

FIG. 15 shows an exemplary embodiment of loading a rectified chart.

FIG. 16 shows an exemplary embodiment of reading bar heights in pixels.

FIG. 17 shows an exemplary embodiment of determining data label coordinates.

FIG. 18 shows an exemplary embodiment of determining data labels.

FIG. 19 shows an exemplary embodiment of correcting erroneous data labels.

FIG. 20 shows an exemplary embodiment of converting charts percentages to chart readings.

FIG. 21 shows an exemplary embodiment of determining data label coordinates.

FIG. 22 shows an exemplary embodiment of determining data labels.

FIG. 23 shows an exemplary embodiment of correcting erroneous data labels.

FIG. 24 shows an exemplary embodiment of translating data labels to months.

FIG. 25 shows an exemplary operating environment.

### DETAILED DESCRIPTION

Although the detailed description contains many specifics, these should not be construed as limiting the scope of the invention but merely as illustrating different examples and aspects of the invention. It should be appreciated that the scope of the invention includes other embodiments not discussed in detail herein. Various other modifications, changes, and variations, which will be apparent to those skilled in the art, may be made in the arrangement, operation, and details of the methods and processes of the present invention disclosed herein without departing from the spirit and scope of the invention as described.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The word “exemplary” is used herein to mean “serving as an example, instance, or illustration.” Any implementation described herein as “exemplary” is not necessarily to be construed as advantageous over other implementations.

In accordance with some aspects of the computer-implemented systems and methods of the present embodiments, historical utility consumption data of a dwelling are analyzed and extracted from one or more utility bills.

As referred to herein, the term “dwelling” is meant to include any building, including a single family home, multi-family home, condominium, townhouse, industrial building, commercial building, public building, academic facility, governmental facility, etc. Additionally, the “historical utility consumption data” is meant to include any utility consumption data including, but not limited to electricity data, natural gas data, and water data. It is further contemplated that the historical utility consumption data may include data relating to other recurring service consumed that is substantially associated with the dwelling, for example, Internet service, cellular voice or data service, etc.

Historical utility consumption data, often captured in one or more bills or invoices, are key indicators to determine energy consumption efficiency. However, obtaining complete information from a bill can be a time consuming and burdensome process. One characteristic of many utility bills is that historical data is often presented in graphic forms, representing the utility consumption for a period of time, such as a year. While quantitative data can be displayed as a list or table of numbers, it is often display as data as a graph or chart. Such graphs and charts use visual elements to provide context for displayed data, to better express the relative values of different entries, and to enable visual comparisons of values. One example of a commonly used graph is a bar graph. Bar graphs display each data entry as a fixed-width rectangle, or bar, having a height representing that entry's numerical value. For example, utility consumption for a period of time can be presented as one or more bar graphs, where each bar represents the utility consumption for a time period, such as a billing month or calendar month. Alternatively, the historical consumption data may be represented as line charts, pie charts, pyramid charts, etc.

One aspect of the present computer-implemented systems and methods comprises extracting historical utility consumption data from one or more utility bills. More specifically, aspects of the present disclosure comprises receiving a file such as an image or PDF comprising one or more graphs or charts, identifying the graphs or charts within the file, processing the file, including, in one aspect, applying OCR technology to process the file, analyzing the processed image or PDF, and extract historical utility consumption data from that graphs or charts of the processed image or PDF.

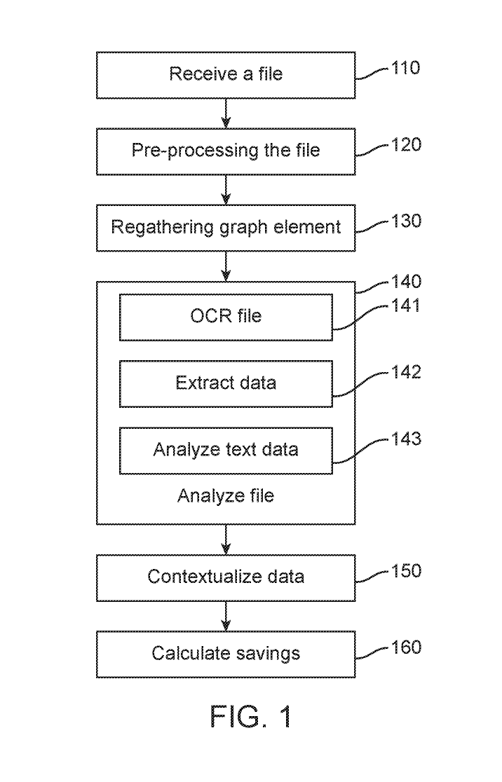

FIG. 1 exemplifies one embodiment of the present disclosure. In aspect of the present disclosure contemplates methods and systems of obtaining historical utility consumption data, where at step 110, a system receives a file, such as a file of a utility bill. As described herein, a file can be an image file can be a JPEG, TIFF, PNG or other image file type. In one aspect, the file can also be a PDF or any other file types containing data of a bill. In one aspect, the file may be received by the system after a user upload the file via a mobile device such as a smartphone. In another aspect, the file may be received by the system after a user upload the file via a computer. In yet another aspect, the file may be received by the system by connecting to a database or alternatively or additionally, via an API interface.

At step 120, aspects of processing the file comprises pre-processing the image file which may include A) determine the quality or suitability of the file and/or B) pre-processing the file to improve the quality or suitability of the file. In terms of determining the quality or suitability of the file, in one aspect, the EXIF data of the file may be analyzed to determine the characteristics of the file. For example, attributes of the file, such as the camera lens, image processor, camera model, ISO, exposure, shutter speed, aperture, etc. may be used to determine the quality or suitability of the file. In one embodiment, the system may contain or connected to one or more databases containing matrixes of image characteristics data correlated with suitability scores. In one embodiment, based on the score, the system can determine whether the file is suitable for further processing. Additionally, the system may be configured to provide feedback to the user based on determined quality. In one aspect, the feedback may be that the file submitted is of insufficient quality for further processing. In another aspect, the feedback may be to provide specific suggestions to the user to improve image quality. The suggestions may be to alter ISO, shutter speed, aperture, distance, orientation, etc. of the image capture.

In another aspect, aspects of processing the file comprises pre-processing the image file which may include pre-processing the file to improve the quality or suitability of the file. In one embodiment, the system may be configure to rotate the image file, in a case where the file was uploaded by a utility consumer in a different orientation than expected. Furthermore, in another aspect, layout analysis may be conducted to identify columns, paragraphs, captions, etc., and separating text and graphic of the files

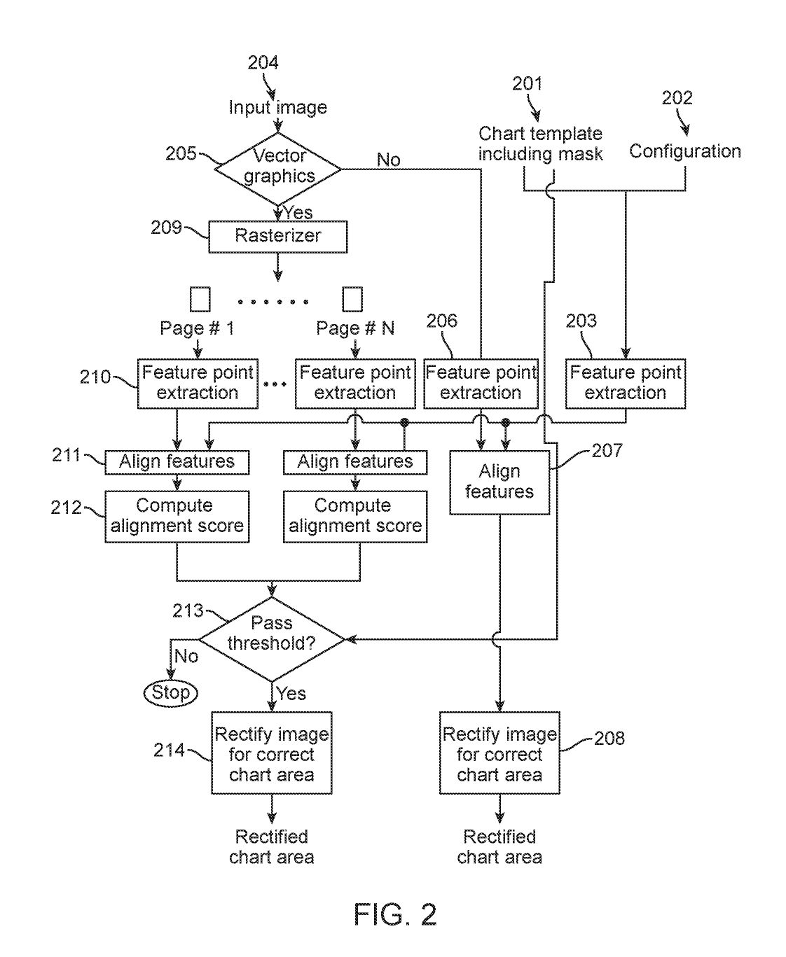

At step 130, aspects of the system and method comprises identifying or registering one or more areas containing a graph element. In embodiment, the identifying or registering one or more areas containing a graph element comprises identifying one or more chart elements within the file. A chart element may be a bar chart, a pie chart, a line chart or a pyramid chart, or any other chart types. In one embodiment, and as described in greater detail as well as illustrated FIG. 2, the identifying or registering comprises using a template of an existing file with the chart element identified either through manual configuration, training, or machine learning. The template can then be correlated with the file to identify the location and area of the chart element.

Alternatively, in another embodiment, the system may be configured to identify a bar chart element in the file by first determine whether each connected area may be a rectangle. Thereafter, if it is determined that each connected area of image file may be a rectangle, then the difference of the direction of each rectangular connected area may be determined. In one aspect, the two edges of each rectangular connected area that may be perpendicular to the major direction may be classified into two groups. In an embodiment, the edge that may be farther from the origin and may be classified into a first group and the other edge may be classified into a second group. In one aspect, the system is configured to determine whether all the edges from one of the groups may be on a line segment. In another embodiment, the system may be configured to determine whether the edges may be connected and their original polylines could be a line segment by computing the minimal bounding box of the polylines and, if the ratio between maximum (height, width) and minimum (height, width) of the bounding box may be greater than a certain value, then the polylines are considered to be a line segment. If so, then an indication that a bar chart is recognized may be returned. In one aspect, the shared line segment may be considered the X-axis of the bar chart. In another aspect, the Y-axis may be recognized from the edges perpendicular to X-axis. In yet another aspect, the arrow heads of the X and Y axis may be recognized using the shape recognizer. In one embodiment, Pie chart and line chart can be similarly determined using associated shape and imaging recognition techniques.

At step 140, both the text and the chart elements from the file are analyzed. In one aspect, the file is first subjected to image file to optical character recognition processing (OCR) to convert aspects of the image file into machine-encoded text. In one embodiment, at step 141, the system is configured to use Tesseract optical character recognition engine. In another embodiment, various other OCR engine maybe used.

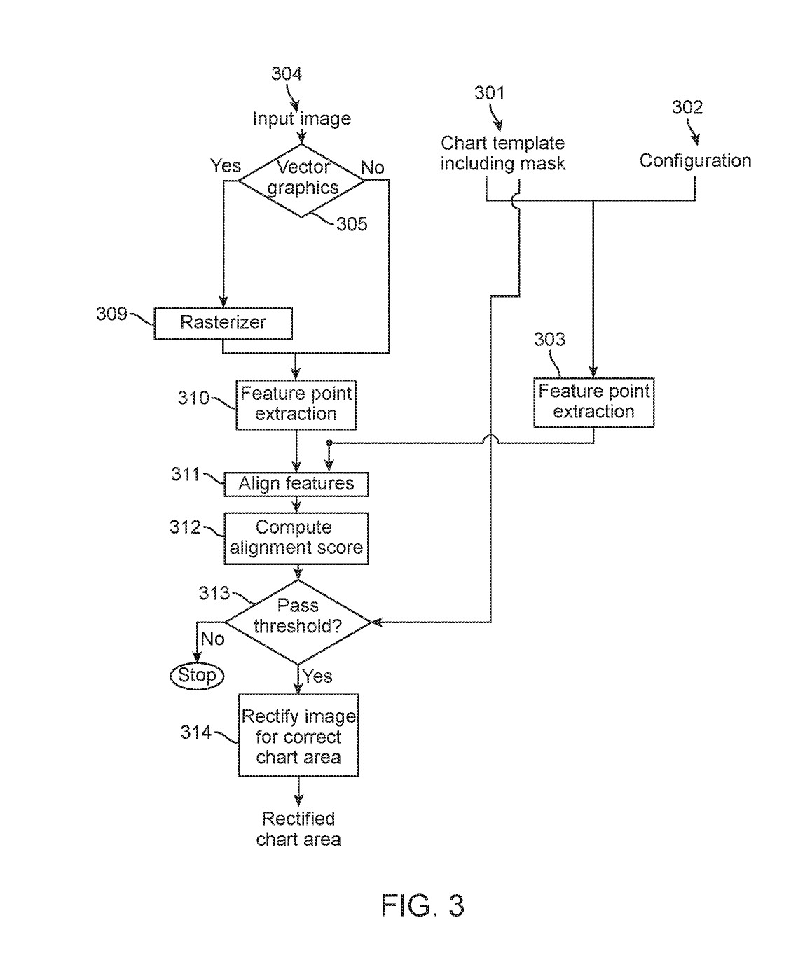

Thereafter, at step 142, the consumption data is extracted from the chart elements by analyzing aspects of the chart elements as described and illustrated in FIG. 3. In one embodiment, to determine the value indicated by the bar elements of a bar chart, the height is calculated by finding the difference between the top of the bar and the x-axis. Thereafter, to determine the relative position of a bar, the absolute position of a bar on the x-axis is calculated. Thereafter, a place-holder value is assigned to each of the bar based on the value of the bar and the relative difference in height.

In one aspect, the extracted utility data comprises utility data over several billing cycles. At step 143, text element is also analyzed and relevant data is extracted to produce contextual data such as the identity of utility provider, type of utility, timeframe, location of the dwelling, etc. In one aspect, contextual data comprises textual elements from the chart element, such as the unit of measurement, labeling, and legends.

Additionally and optionally, at step 150, the extracted data from the chart element is further processed and is modified with the contextual element to produce a contextualized utility data. In one aspect, the contextual data can be divided into graphical contextual data and bill contextual data. Graphical contextual data comprise labelling of the x-axis and y-axis of the chart element, unit of measurement, or any other data that is relevant to the data interpretation of the chart element.

For example, graphical contextual data may comprise title of the graph, legend of the graph, labelling of chart elements, etc. In one aspect, the bill contextual data comprises data regarding the address of the dwelling. In another aspect the bill contextual data comprises data regarding the identity of the utility provider. In yet another aspect, the bill contextual data comprises data regarding the pricing tier of the utility provider, etc.

For example, the consumption data extracted from the chart element may be correlated with a specific utility provider, a specific geographic region, a specific demographic group to contextualize the consumption data.

Additionally and optionally, at step 160, the contextualized utility data is used for utility disaggregation and savings calculations or presented to the user.

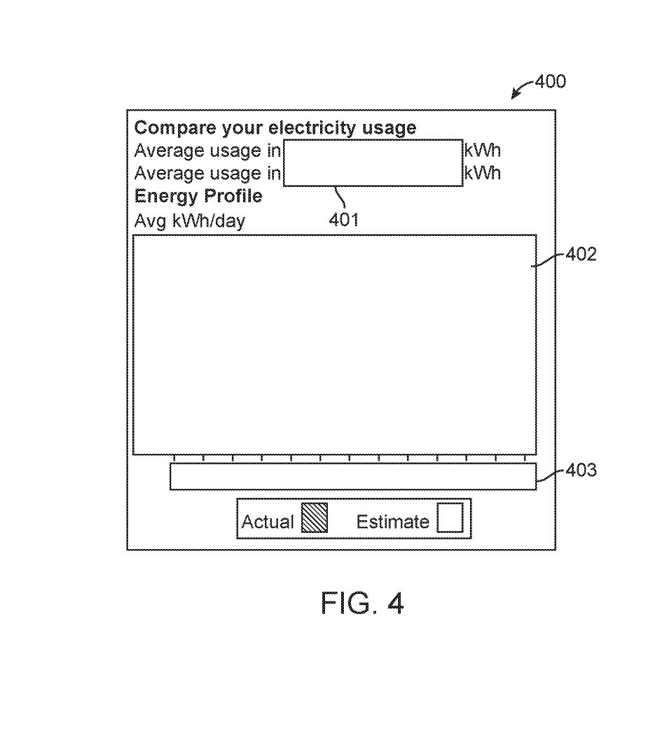

Referring now to FIG. 2, which shows an exemplary method for registering an image of a utility bill. Corresponding exemplary depictions of the steps in FIG. 2 are shown in FIGS. 4-13. At step 201 a chart template for a specific utility provider is loaded to an embodiment of the present system. In one aspect, a user selects the desired utility provider. Additionally or alternatively the system may determine the utility provider based on features of an image of a utility bill and/or machine learning.

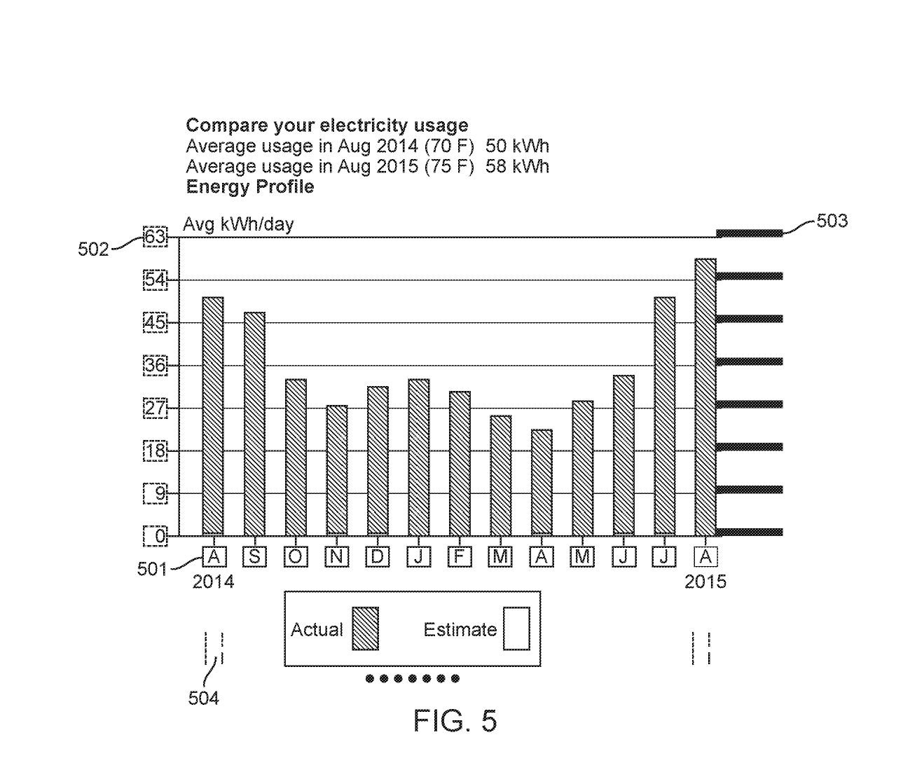

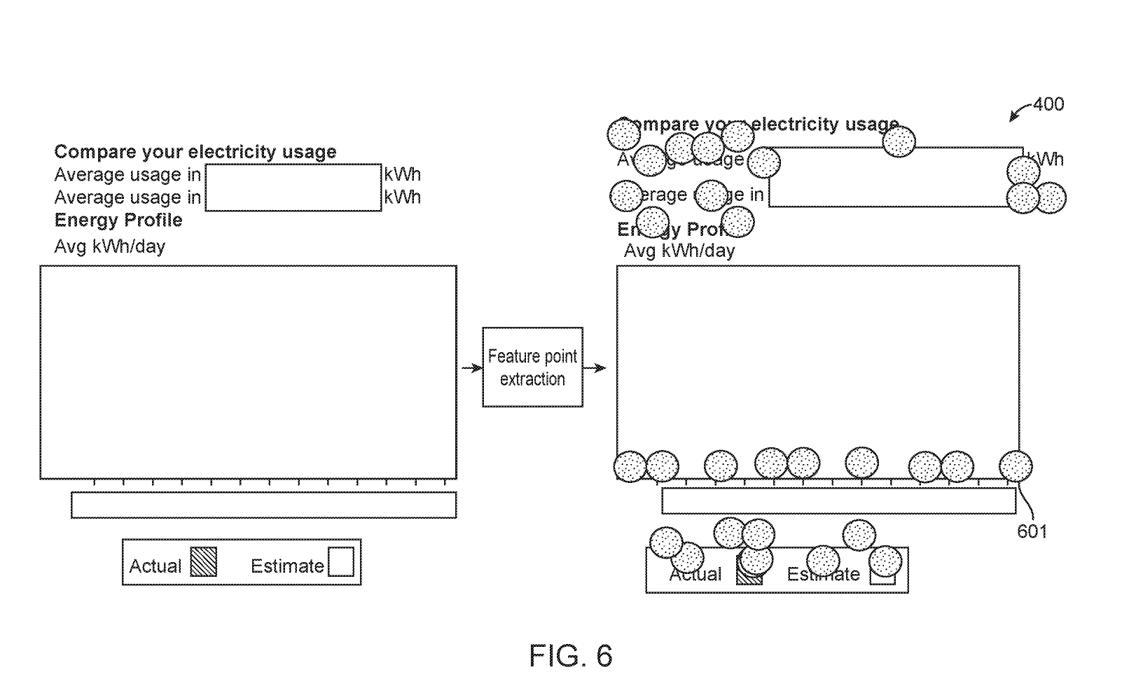

In one embodiment, the template may comprise a mask or template of a chart or graph present on utility bill from the desired utility provider. FIG. 4 depicts an exemplary template 400. The template 400 indicates locations 401, 402, 403 of relevant information on the utility bill such as usage values, data labels, graph locations, etc. At step 202 and shown in FIG. 5 a template configuration is determined and loaded. While exemplary bar graphs are shown in the figures, any type of graph or chart may be used. Further various graphs may have reversed axes. Data x label bounding positions/locations 501, Y label bounding positions/locations 502, y tick position/locations 503, x bar left and right positions/locations 504 are determined. At step 203 and depicted in FIG. 6 various feature points 601 of template 400 are calculated.

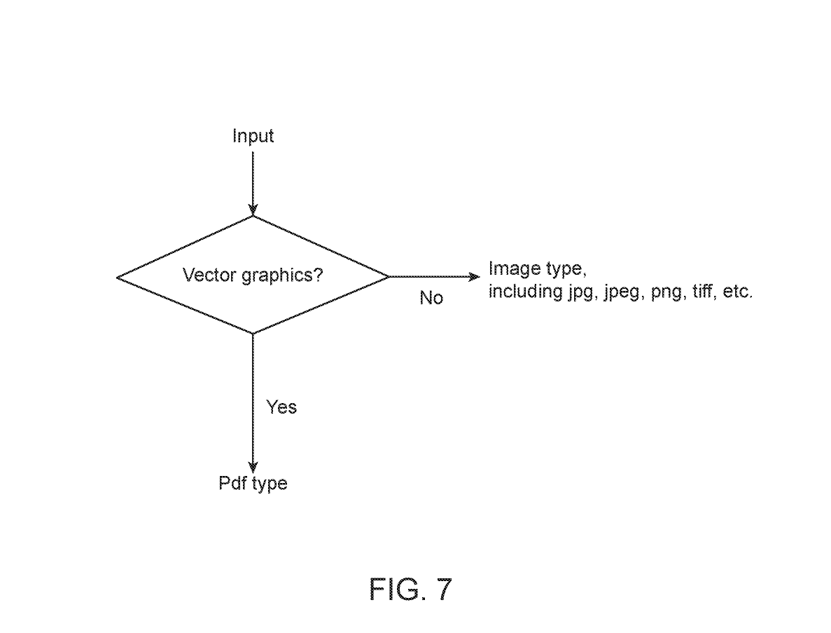

At step 204 an image of a user's utility bill in input by the user. In an embodiment the system captures an image of the utility bill. The system my provided cues to the user to improve image quality. Additionally or alternatively the user may input a preexisting image file. At step 205 and depicted in FIG. 7 the system determines the image type. The system may determine if the graphic is a vector graphic or a raster graphic.

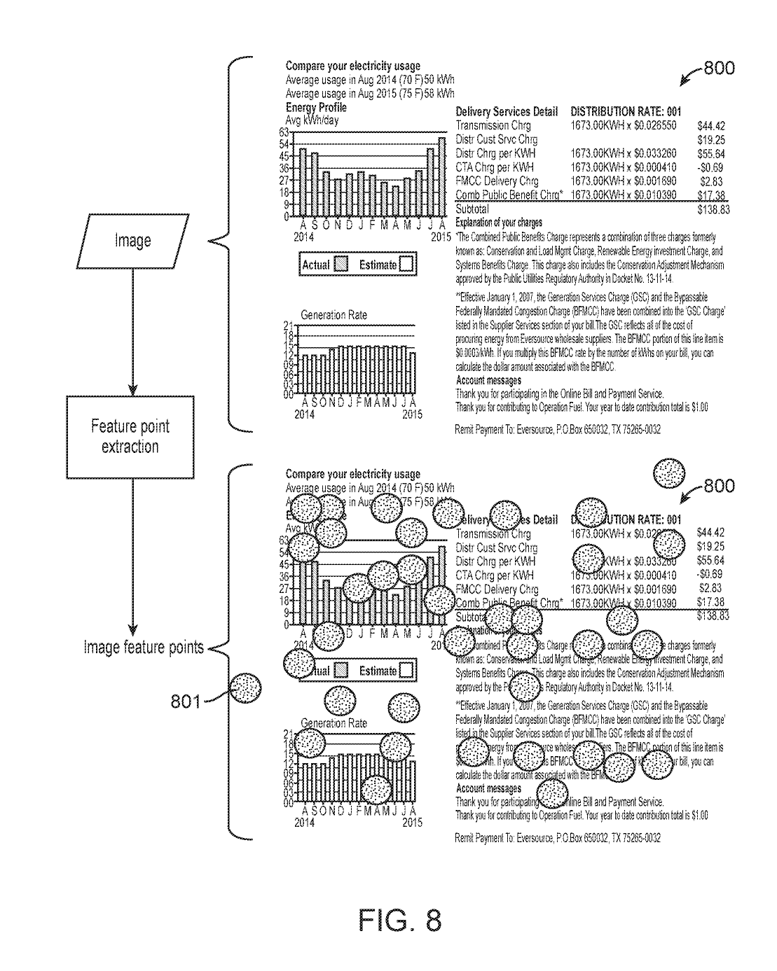

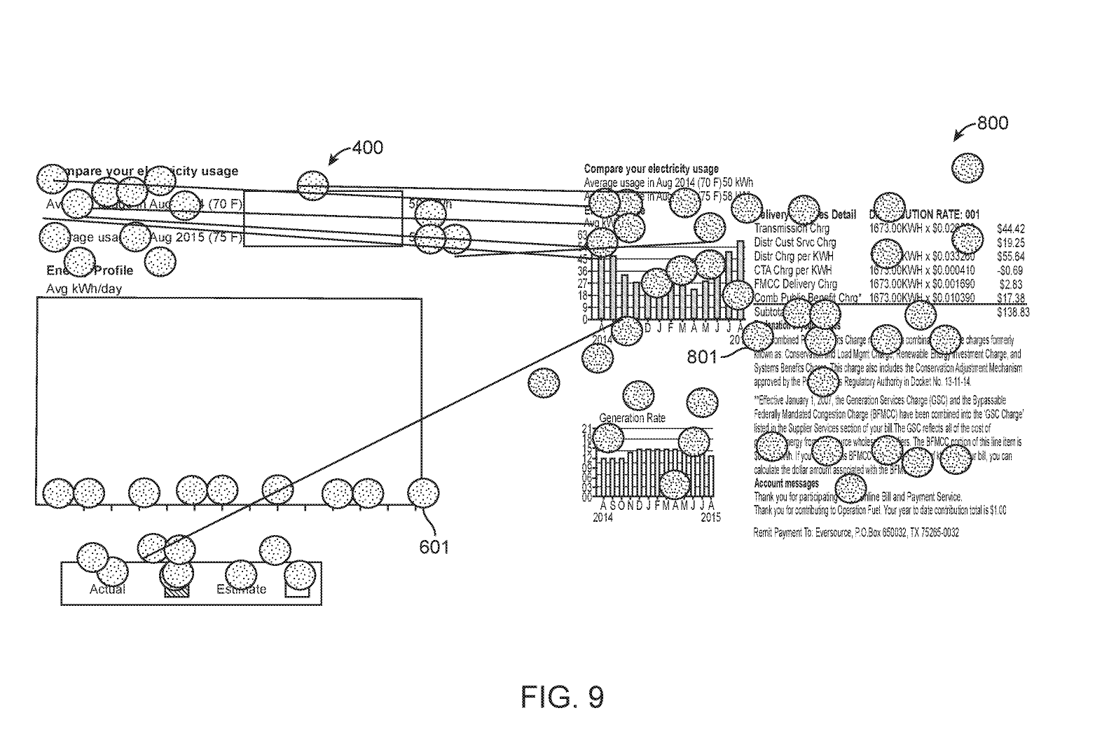

If at step 205 the system determines that the image is a raster type such as a JPEG, PNG, BMP, TIFF, etc., then at step 206 and depicted in FIG. 8 feature points 801 of the image 800 are determined. At step 207 and depicted in FIG. 9 feature points 601 of the template 400 are aligned with the corresponding feature points 801 of the image 800. A transformation matrix is then calculated based on the feature point 401, 801 correspondence. Optionally a feature point correspondence score may be determined and compared to a threshold score to determine if the quality of the image is sufficient.

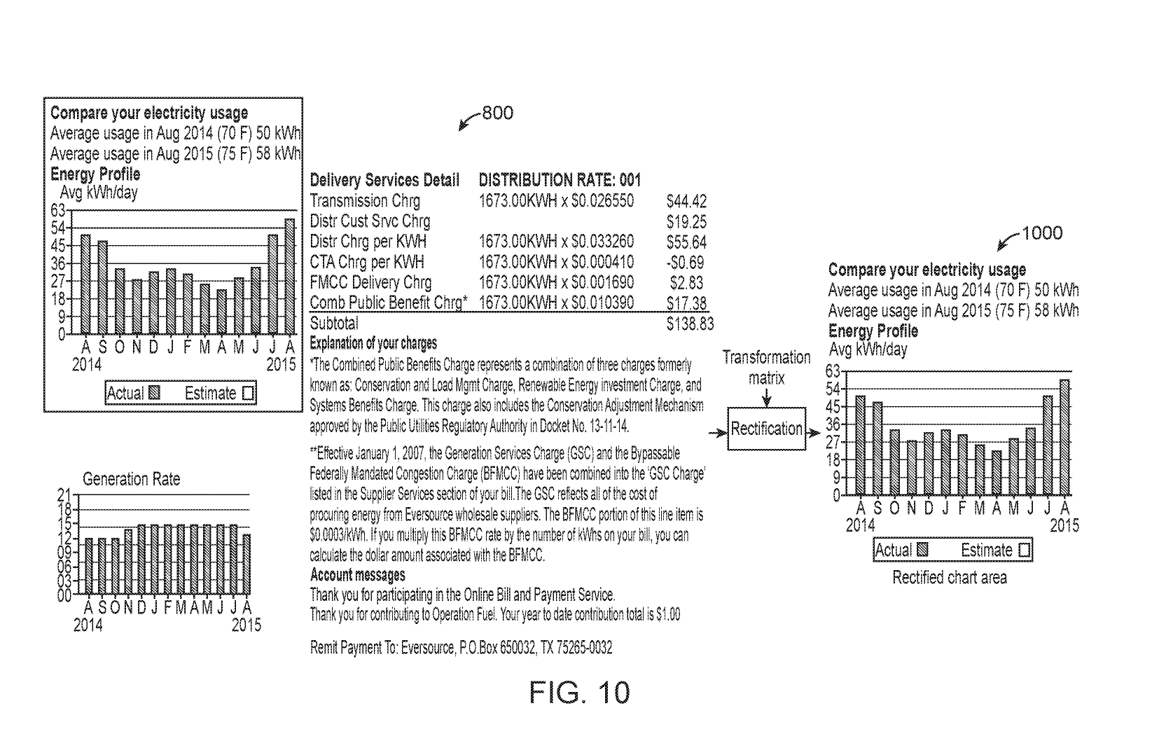

At step 208 and depicted in FIG. 10 the image 800 is processed using the transformation matrix to create a rectified chart area 1000. In an embodiment, rectifying the image 800 comprises cropping the relevant portion of the image 800.

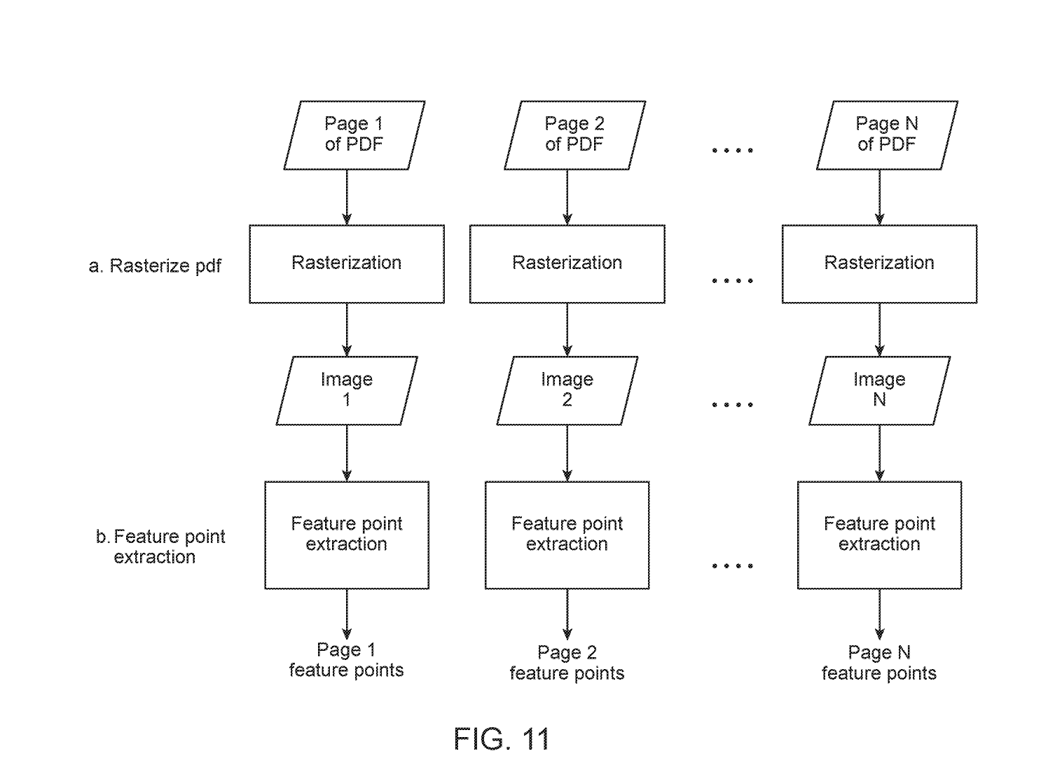

If at step 205 the system determines that the image is a vector type, such as a PDF, then at step 209 and depicted in FIG. 11 the image is rasterized to create a raster image. If the vector graphic, for example a PDF file, contains multiple pages the system may create separate raster images and process them separately.

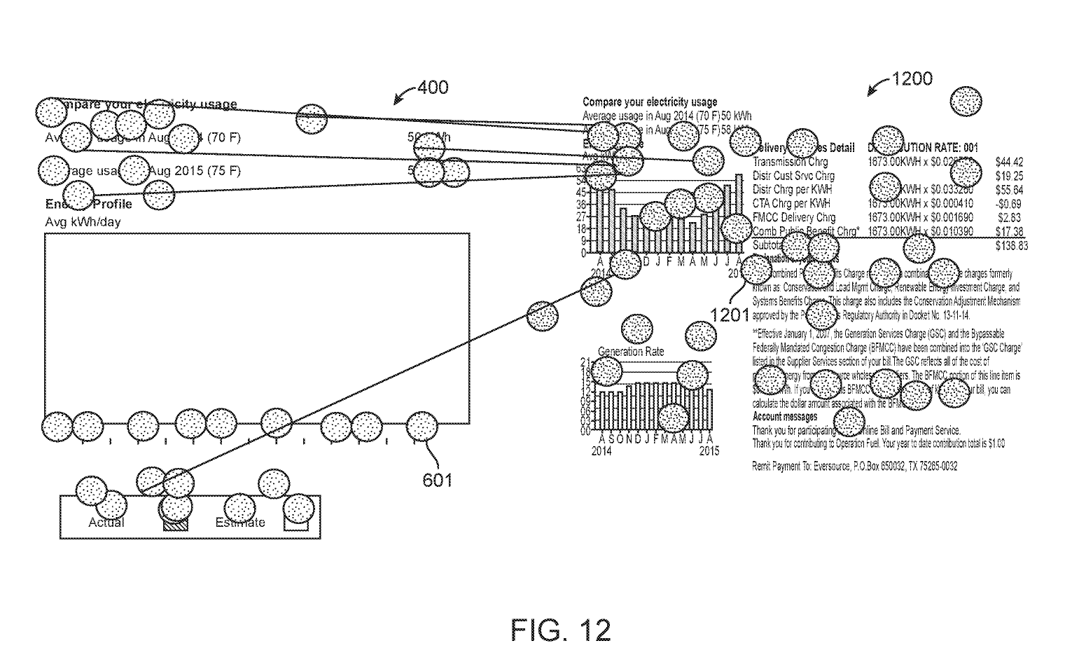

At step 210 feature points 1201 of the image 1200 are determined for each page. At step 211 and depicted in FIG. 12 feature points 601 of the template 400 are aligned with the corresponding feature points 1201 of the image 1200 for each page. A transformation matrix is then calculated based on the feature point 401, 1201 correspondence. A feature point correspondence score may be determined and compared to a threshold score. In an embodiment the threshold comparison may be used to determine if the quality of the image is sufficient. The threshold comparison may also be used to determine the relevant page containing the desired graph.

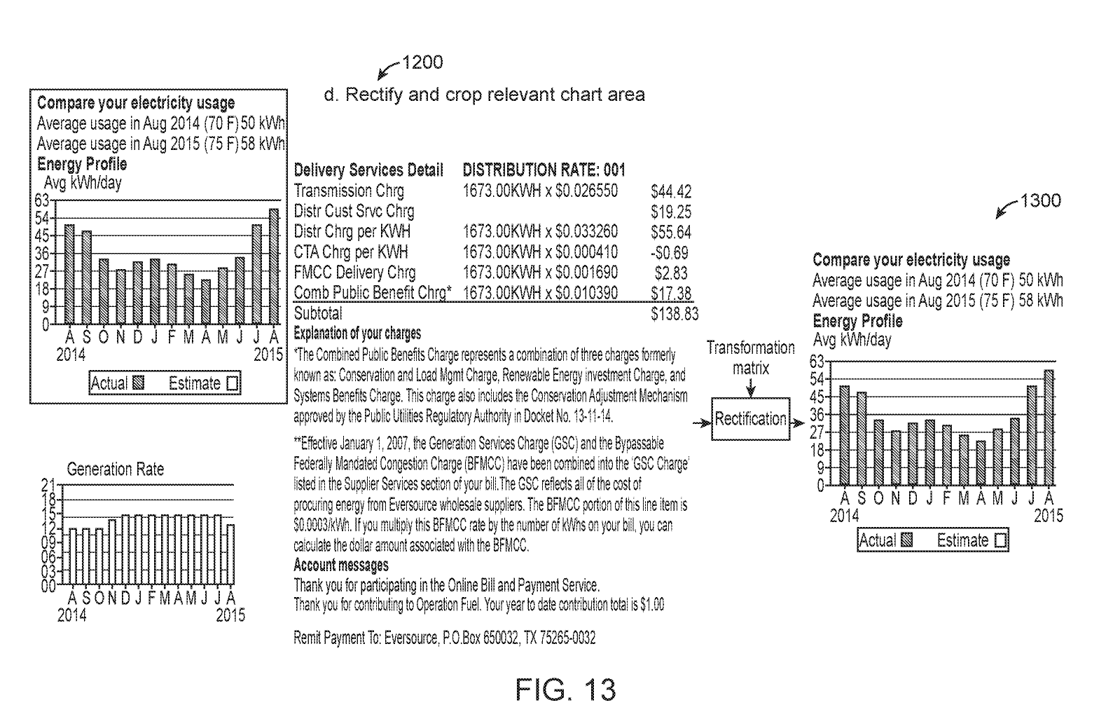

If the image passes the threshold then at step 215 and depicted in FIG. 13 the image 1200 is processed using the transformation matrix to create a rectified chart area 1300. In an embodiment, rectifying the image 1200 comprises cropping the relevant portion of the image 1200.

FIG. 3 depicts an alternative embodiment of method for registering an image of a utility bill. Once rasterized the steps are the same.

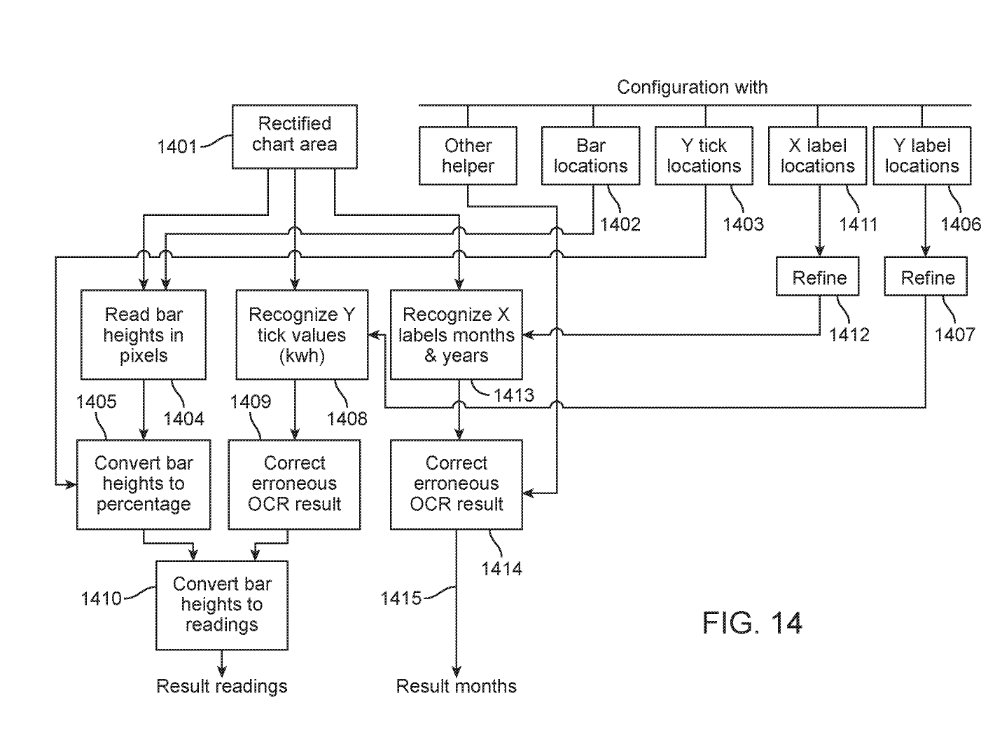

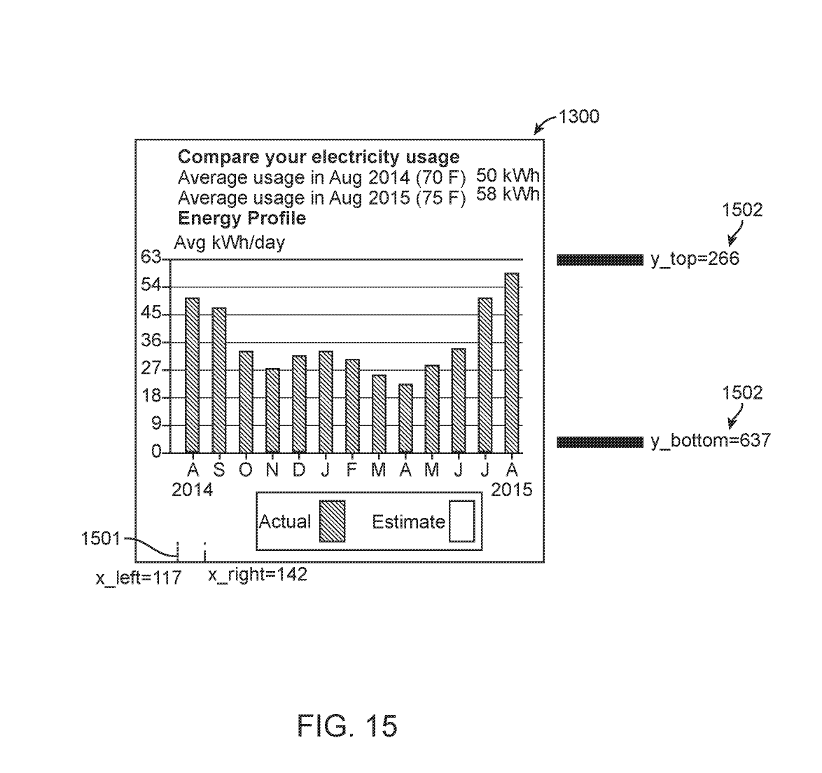

FIG. 14 depicts an embodiment of a method of reading a utility bill chart. Corresponding exemplary depictions of the steps in FIG. 14 are shown in FIGS. 15-24. At step 1401, and depicted in FIG. 15, the rectified chart area is loaded. At step 1402 left and right bar x coordinates 1501 are determined. At step 1403 top and bottom y tick locations 1502 are determined.

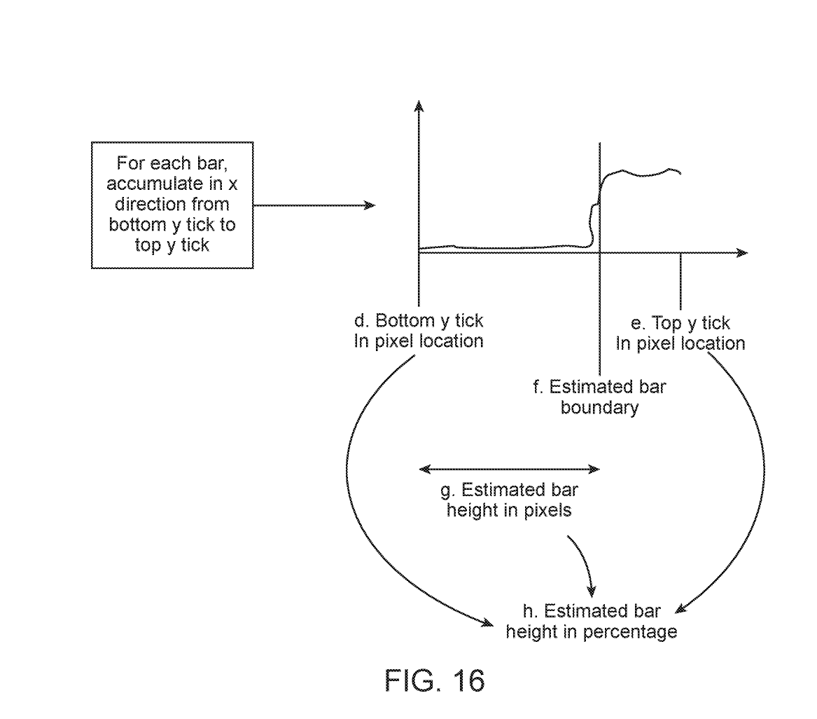

At step 1404, and depicted in FIG. 16, bar heights are read in pixels. In an embodiment, for each bar the system accumulates in the x direction from bottom y tick to the top y tick and estimates the height of the bar in pixels. At step 1405 the bar heights are converted from pixels to a percentage based on the y lick locations.

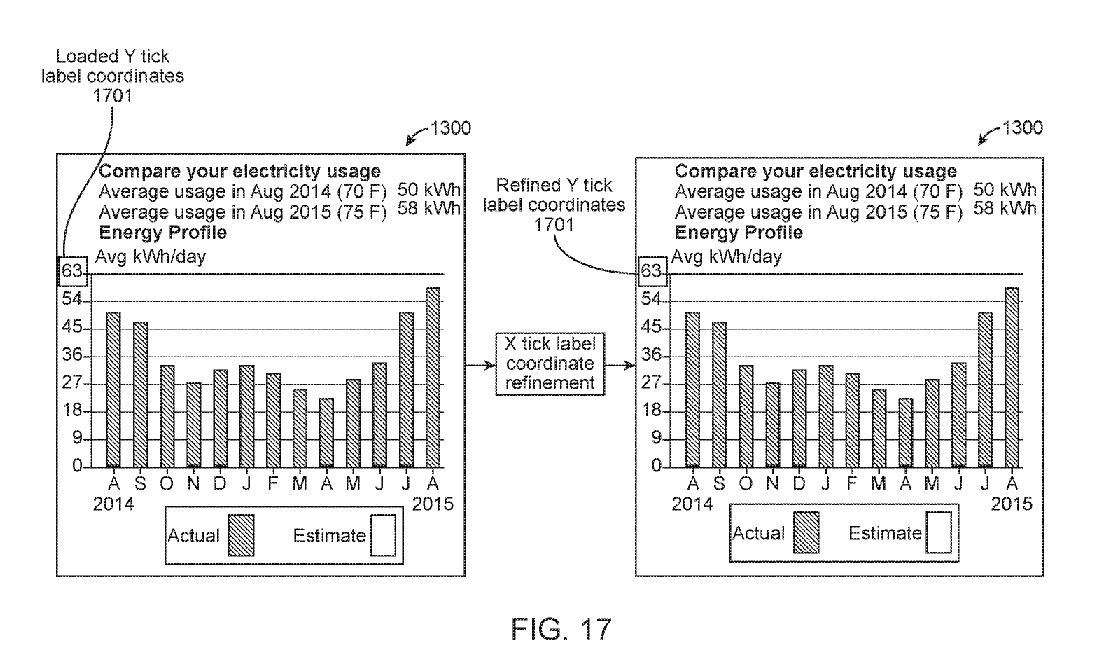

At step 1406, and depicted in FIG. 17, y label coordinate 1701 are determined. At step 1407 y label coordinates are refined.

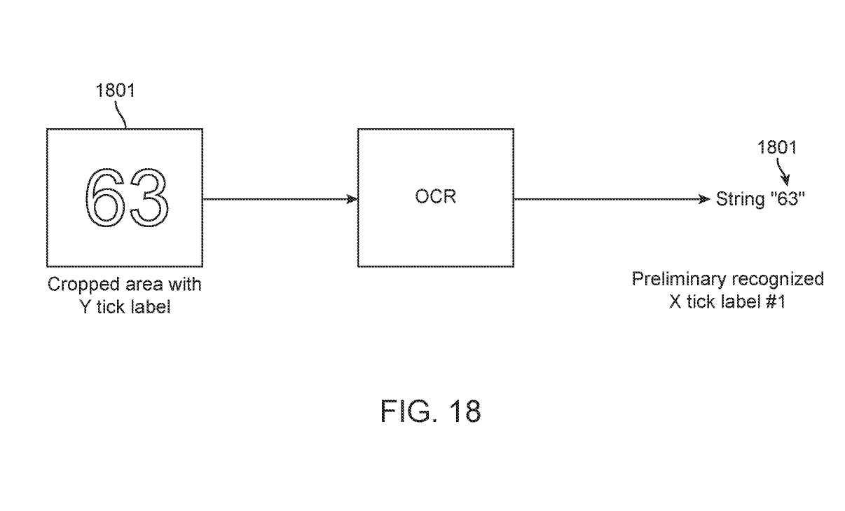

At step 1408, and depicted in FIG. 18 y data labels 1801 are determined using optical character recognition (OCR).

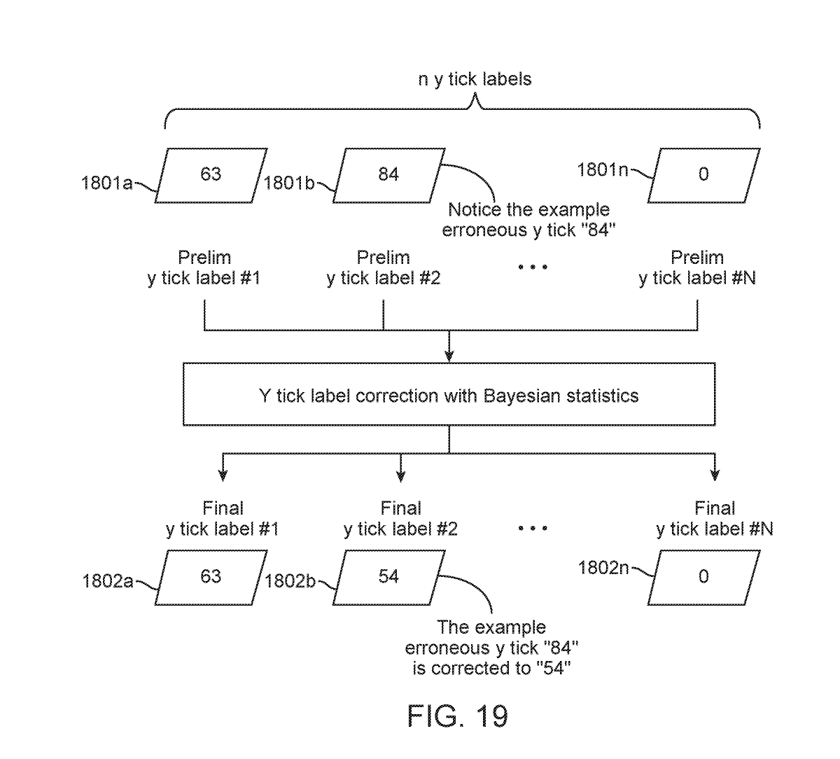

At step 1409, and depicted in FIG. 19, erroneous y labels are corrected. In an embodiment Bayesian statistics are used to correct preliminary y tick labels 1901a-1901n to produce the final y tick labels 1902a-1902n. As an example shown in FIG. 19, erroneous y label 1901b is corrected from “84” to “54”.

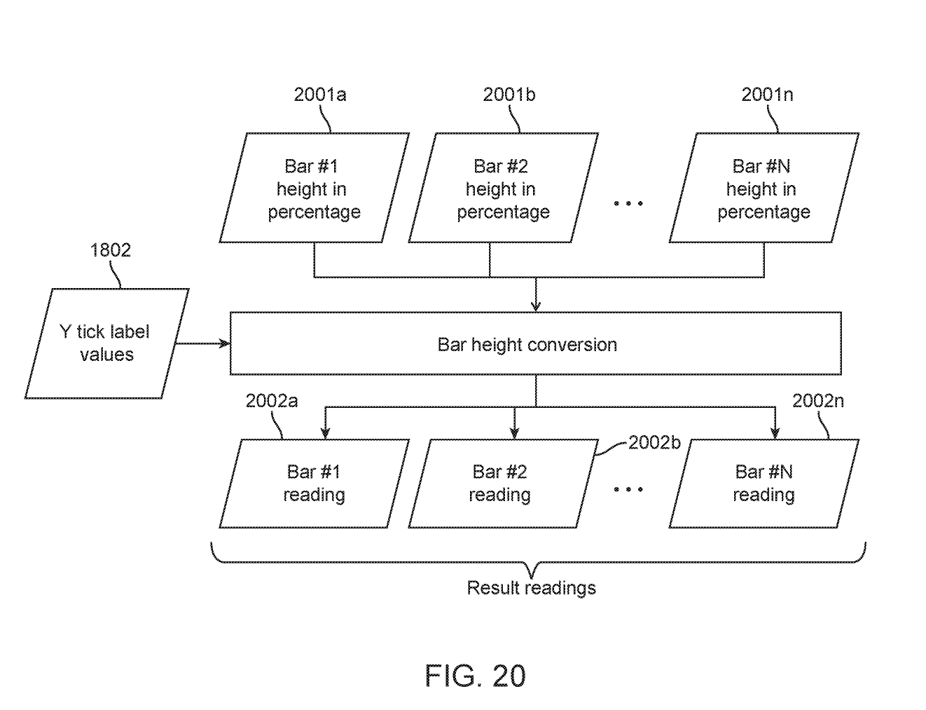

At step 1410, and depicted in FIG. 20, bar heights are converted from percentages 2001a-2001n to bar height readings 2002a-2002n.

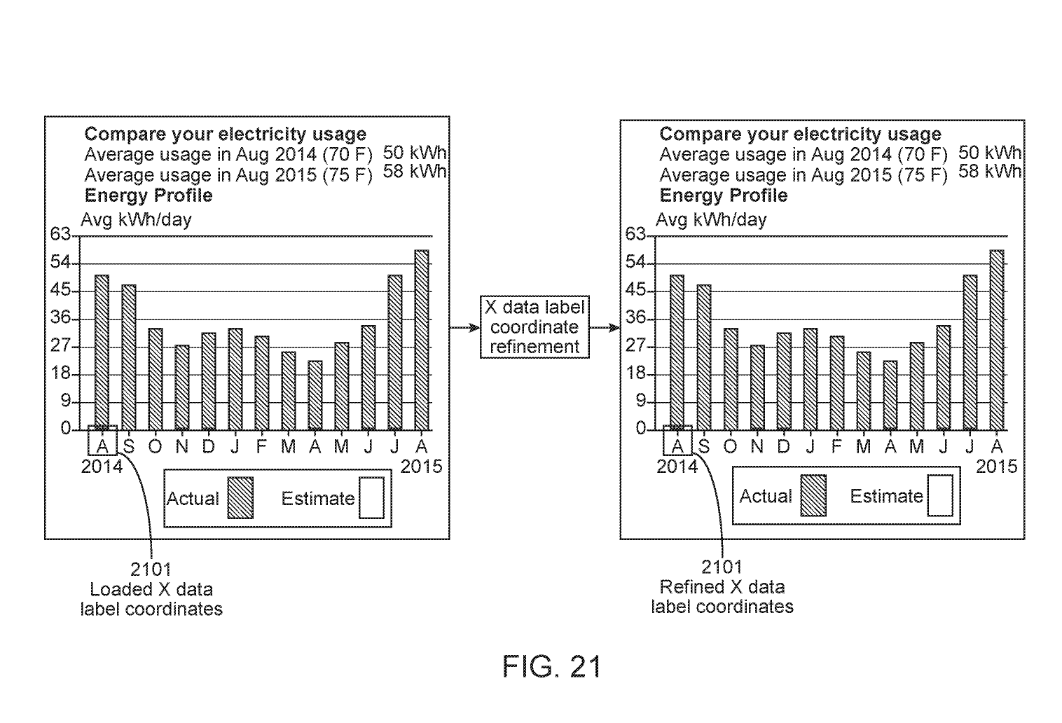

At step 1411, and depicted in FIG. 21, x label coordinates 2101 are determined. At step 1412 x label coordinates are refined.

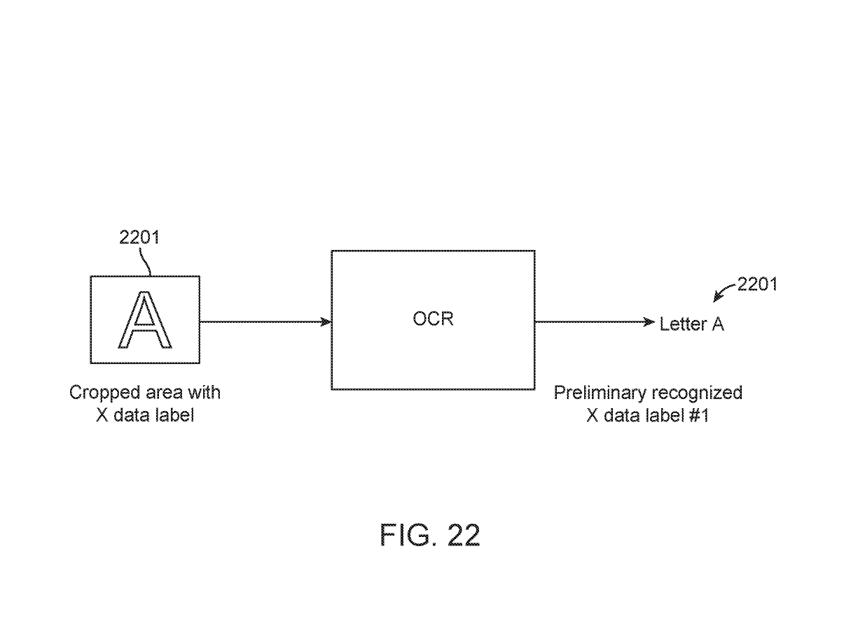

At step 1413, and depicted in FIG. 22, x data labels 2201 are determined using optical character recognition (OCR).

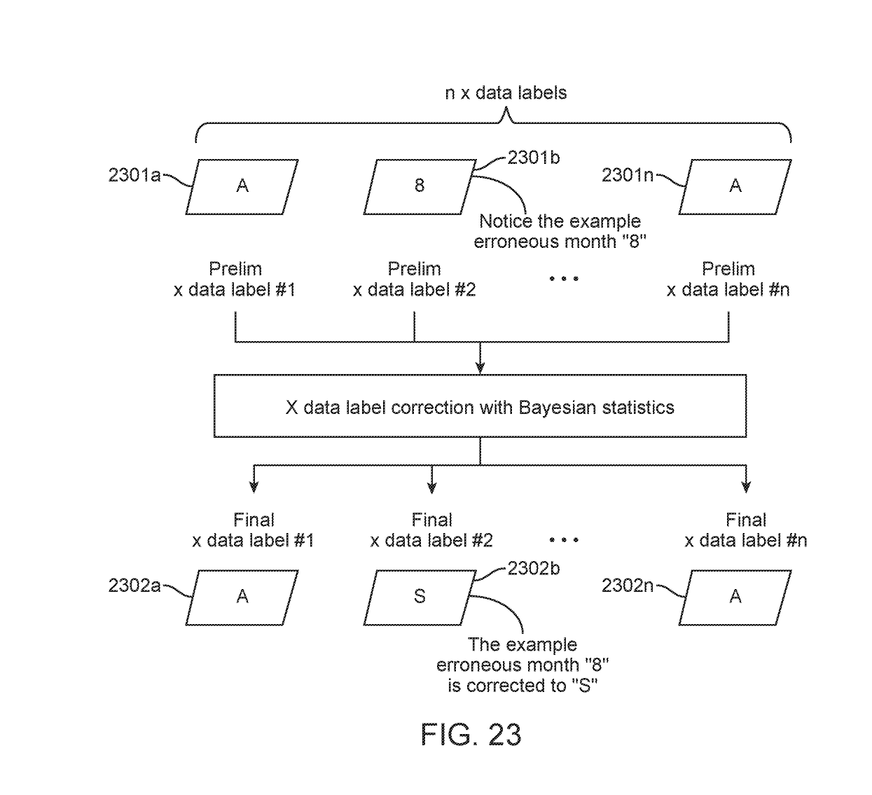

At step 1414, and depicted in FIG. 23, erroneous x labels are corrected. In an embodiment Bayesian statistics are used to correct preliminary x data labels 2301a-2301n to produce the final x data labels 2302a-2202n. As shown in FIG. 22, erroneous x label 2301b is corrected from “8” to “S”.

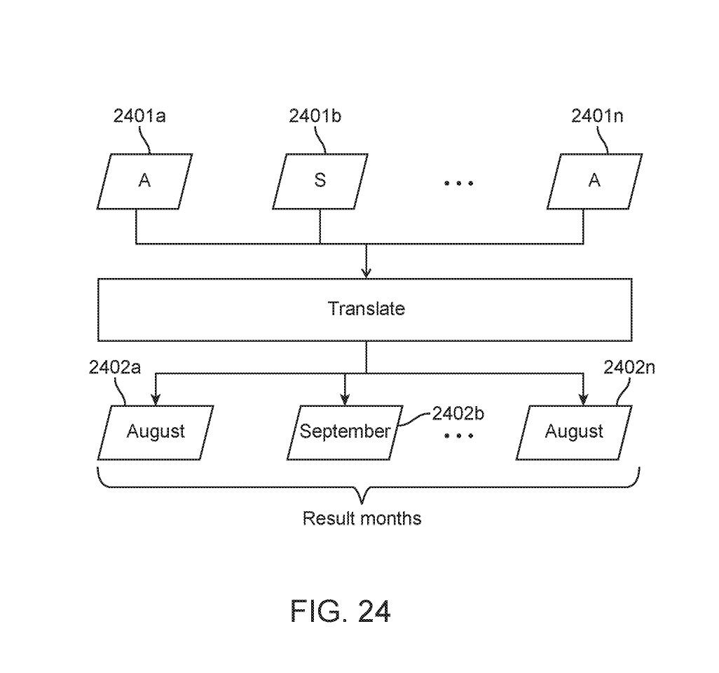

At step 1415, and depicted in FIG. 24, x data labels 2401a-2401n are translated to months 2402a-2402n.

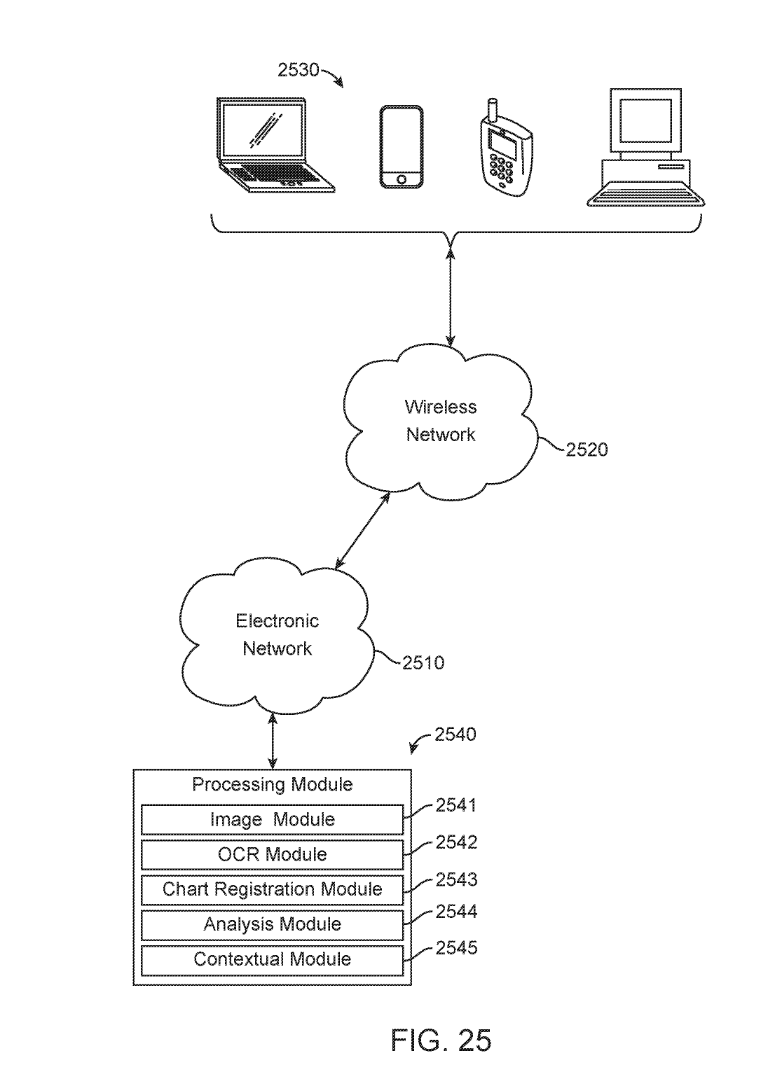

Referring now to FIG. 25, which illustrates components of one embodiment of an environment in which the present disclosure may be practiced. It should be noted, that not all the components described herein may be required to practice present embodiments, and variation may be made without departing from the scope of the present disclosure.

FIG. 25 shows an exemplary operating environment comprising an electronic network 2510, a wireless network 2520, at least one end-use device 2530 and a processing module 2540. The electronic network 2510 may be a local area network (LAN), wide-area network (WAN), the Internet, and the like. The wireless network 2520 may be various networks that implements one or more access technologies such as Global System for Mobile Communications (GSM), General Packet Radio Services (GPRS), Enhanced Data GSM Environment (EDGE), Code Division Multiple Access (CDMA), Wideband Code Division Multiple Access (WCDMA), Bluetooth, ZigBee High Speed Packet Access (HSPA), Long Term Evolution (LTE), Worldwide Interoperability for Microwave Access (WiMAX), and the like.

The wireless network 2520 and the electronic network 2510 are configured to connect the end-use device 2530 and the processing module 2540. It is contemplated that the end-use device 2530 may be connected to the processing module 2540 by utilizing the electronic network 2510 without the wireless network 2520. It is further contemplated that the end-use device 2530 may be connected directly to the processing module 2540 without utilizing a separate network, for example, through a USB port, Bluetooth, infrared (IR), firewire, thunderbolt, ad-hoc wireless connection, and the like.

The end-use device 2530 may be desktop computers, laptop computers, tablet computers, personal digital assistants (PDA), smart phones, and the like. The end-use device 2530 may comprise a processing unit, memory unit, one or more network interfaces, video interface, audio interface, and one or more input devices such as a keyboard, a keypad, or a touch screen.

The input devices may also include auditory input mechanisms such as a microphone, graphical or video input mechanisms, such as a camera and a scanner. The end-use device 2530 may further comprise a power source that provides power to the end-use devices 2530 including AC adapter, rechargeable battery such as Lithium ion battery and non-rechargeable battery.

The memory unit of the end-use device 2530 may comprise random access memory (RAM), read only memory (ROM), electronic erasable programmable read-only memory (EEPROM), and basic input/output system (BIOS). The memory unit may further comprise other storage units such as non-volatile storage including magnetic disk drives, flash memory and the like.

The end-use device 2530 may further comprise a display such as liquid crystal display (LCD), light emitting diode (LED), organic light emitting diode (OLED), cathode ray tube (CRT) display and the like. Optionally, the end-use devices 2530 may comprise one or more global position system (GPS) transceivers that can determine the location of the end-use device 2530 based on the latitude and longitude values.

In one embodiment, the network interface of the end-use device 2530 may directly or indirectly communicate with the wireless network 2520 such as through a base station, a router, switch, or other computing devices. The network interface of the end-use device 2530 may be configured to utilize various communication protocols such as GSM, GPRS, EDGE, CDMA, WCDMA, Bluetooth, ZigBee, HSPA, LTE, and WiMAX. The network interface of the end-use device 2530 may be further configured to utilize user datagram protocol (UDP), transport control protocol (TCP), Wi-Fi and various other communication protocols, technologies, or methods.

Additionally, the end-use device 2530 may be connected to the electronic network 2510 without communicating through the wireless network 2520. The network interface of the end-use device 2530 may be configured to utilize LAN (T1, T2, T3, DSL, etc.), WAN, or the like.

In one embodiment, the end-use device 2530 is a web-enabled device comprising a browser application such as the Microsoft Internet Explorer, Google Chrome, Mozilla Firefox, Apple Safari, Opera, or any other browser application that is capable of receiving and sending data, and/or messages through a network. The browser application may be configured to receive the display data such as graphics, text, multimedia using various web-based languages such as hyperText Markup Language (HTML), Handheld Device Markup Language (HDML), eXtendable markup language (XML), and the like.

The end-use device 2530 may comprise other applications including one or more messengers configured to send, receive, and/or manage messages such as email, short message service (SMS), instant message (IM), multimedia message services (MMS) and the like. The end-use device may further comprise mobile application, such as iOS apps, Android apps, and the like.

Furthermore, the end-use device 2530 may include a web-enabled application that allows a user to access a system managed by another computing device, such as the profile generator 2540. In one embodiment, the application operating on the end-use device 2530 may be configured to enable a user to create, manage, and/or log into a user account residing on the profile generator 2540.

In general, the end-use device 2530 may utilize various client applications such as browser applications, a dedicated applications, or a web widgets to send, receive, and access content such as energy consumption data and energy saving data residing on the profile generator 2540 via the wireless network 2520, and/or the electronic network 2510.

In one aspect, the end-user device 2530 comprises an image capture module, which can be configured to receive a signal from a sensor such as a camera chip and accompanying optical path. In general, the image capture module and sensor allow a user to obtain an image, or otherwise transform a visual input to a digital form. The images can be viewed via a graphic display which can be configured to be a user interface (e.g., touch screen), and allow the user to view video images.

The processing module 2540 may be one or more network computing devices that are configured to provide various resources and services over a network. For example, the profile generator 2540 may provide FTP services, APIs, web services, database services, processing services, or the like. In one aspect, the processing module 2540 receives an image file from the end-user device 2530 as captured by the image capture module.

In general, the processing module 2540 comprises processing unit, memory unit, video interface, memory unit, network interface, and bus that connect the various units and interfaces. The network interface enables the processing module 2540 to connect to the Internet or other network. The network interface is adapted to utilize various protocols and methods including but not limited to UDP, and TCP/IP protocols.

The memory unit of the processing module 2540 may comprise random access memory (RAM), read only memory (ROM), electronic erasable programmable read-only memory (EEPROM), and basic input/output system (BIOS). The memory unit may further comprise other storage units such as non-volatile storage including magnetic disk drives, flash memory and the like. The processing module 2540 further comprises an operating system and other applications such as database programs, hyper text transport protocol (HTTP) programs, user-interface programs, IPSec programs, VPN programs, account management program, and web service program, and the like. The processing module 2540 may be configured to provide various web services that transmit or deliver content over a network to the end-use device 2530. Exemplary web services include web server, database server, massager server, content server, etc. Content may be delivered to the end-use device 2530 as HTML, HDML, XML, or the like.

In one embodiment, the processing module 2540 comprises an image module 2541, an OCR module 2542, a chart registration module 2543, an analysis module 2544 and optionally and additionally, a contextual module 2545.

In one embodiment, the image module 2541 is configured to analyze the file to determine the image quality and suitability for further analysis. As previously described, the EXIF data may be used to determine the image quality. In another aspect, the image module 2541 is configured to provide feedback either after the file has been analyzed to determine quality and suitability or during the image capture process to provide real-time feedback to the user to best position the image capturing device such as a smartphone to obtain suitable image. In yet another embodiment, guidance may be provided to the user prior to the image capture or file upload to ensure suitable file is obtained by the system.

The image module 2541 may be configured to process the image to ensure proper processing and analysis. In one aspect, the image module 2541 is configured to adjust the orientation and/or alignment of the image.

The OCR module 2542 is configured to perform optical character recognition on images captured via the end use devices 2530. In general, the computer-readable instructions in the OCR module 2540 functions as an OCR engine to process the file transmitted by the end-user device 2530. In one embodiment, the chart registration module 2543 is configured to identify or register the chart element within the file. Once the chart element has been identified, the chart element is isolated and the analysis module 2544 is configured to analyze the chart element to extract the consumption data.

Additionally and optionally, the processing module 2540 further comprises a contextual module 2545 configured to extract contextual data from the textual elements from the image file. In one aspect, the contextual data can be divided into graphical contextual data and bill contextual data. Graphical contextual data comprise labelling of the x-axis and y-axis of the chart element, unit of measurement, or any other data that is relevant to the data interpretation of the chart element.

For example, graphical contextual data may comprise title of the graph, legend of the graph, labelling of chart elements, etc. In one aspect, the bill contextual data comprises data regarding the address of the dwelling. In another aspect the bill contextual data comprises data regarding the identity of the utility provider. In yet another aspect, the bill contextual data comprises data regarding the pricing tier of the utility provider, etc.

The contextual module 2545 is further configured contextualize the value assigned by the analysis module 2544 the chart element to create a contextualized value. For example, by using the contextualized data which indicates that the file is an electricity utility bill, and by utilizing the axis labels and the scales and labels of the y axis and the x axis, the contextual module 2545 is configured to associate aspects of the chart element with a contextualized value. In one embodiment, the contextualized value is monetary amount, in U.S. dollar, for example, of utility paid for a period of a time. In another embodiment, the contextualized value of the sub-element is the amount of utility used, such as Kilowatt hour (kWh), centum cubic feet (CCF), etc.

It is noted that the disclosed methods and systems as described above and illustrated in the corresponding flow diagrams can be implemented by computer program instructions. These program instructions may be provided to a processor to produce a machine, such that the instructions may create means for implementing the various steps specified above and in the flow diagrams.

It is further contemplated that various chart type may be processed by aspects of the present embodiments, including but not limited to bar charts, pie charts, line charts, high/low charts, pyramid charts, etc. It is further contemplated

The computer program instructions may be executed by a processor to cause a series of steps as described and illustrated to be performed by the processor to produce a computer implemented process such that the instructions, which execute on the processor to provide steps for implementing the steps as described. The computer programs instructions may also cause at least some of the steps to be performed in parallel. It is envisioned that some of the steps may also be performed across more than one processor, for example, in a multi-processor computer system. In addition, one or more steps or combination of steps may also be performed concurrently with other steps or combinations of steps, or even in a different sequence than illustrated.

It is further noted that the steps or combination thereof as described above and illustrated in the corresponding flow diagrams may be implemented by special purpose hardware base systems configured to perform the specific steps of the disclosed methods, or various combinations of special purpose hardware and computer instructions.

While the above is a complete description of the preferred embodiments of the invention, various alternatives, modifications, and equivalents may be used. Therefore, the above description should not be taken as limiting the scope of the invention, which is defined by the appended claims.

What is claimed is:

1. A computer-implemented method for identifying utility usage from a historical utility file, comprising:
obtaining a file containing historical utility consumption of a dwelling over a time period;
extracting contextual data from the file;
registering one or more chart elements from file;
extracting one or more values from the chart elements; and
contextualizing the extracted values from the chart elements by applying the contextual data to the extracted value to obtain utility usage data.

2. The method of claim 1, further comprising OCRing the file.

3. The method of claim 1, wherein the registering comprising:
obtaining a historical utility template;
identifying one or more feature points on the template, and
correlating the template points with one more points on the file.

4. The method of claim 1, wherein the chart element is a bar chart.

5. The method of claim 1, wherein the chart element is a pie chart.

6. The method of claim 1, wherein the chart element is a line chart.

7. The method of claim 1, wherein the utility is electricity and the historical utility file is an electricity bill.

8. The method of claim 1, wherein the utility is water and the historical utility file is a water bill.

9. The method of claim 1, wherein the utility is water and the historical utility file is a water bill.

10. The method of claim 1, wherein the utility is natural gas and the historical utility file is a gas bill.

11. The method of claim 1, wherein the contextual data comprises identity of the utility provider.

12. The method of claim 2, wherein the contextual data comprises labels of the x-axis and y-axis.

13. The method of claim 1, wherein the contextual data comprises location information of the dwelling.

14. The method of claim 1, wherein the contextual data comprises seasonal information.

15. The method of claim 6, wherein the utility usage data are the kWh consumed as indicated by the graph component of the graph element.

16. The method of claim 1, wherein the file is an image captured using a photo capturing device.

17. The method of claim 1, further comprising analyzing the image suitability of the file.

18. The method of claim 17, further comprising providing feedback to the user based on the suitability of the file.

19. A computer system for identifying utility usage from a historical utility file, comprising:
a processor, and a non-volatile memory component, wherein the processor is configured to:
obtain a file containing historical utility consumption of a dwelling over a time period; processing the file through optical character recognition (OCR);
identify contextual data from the OCR processed file;
identify one or more chart elements from the OCR processed file comprising one or more chart components;
extract one or more values from the chart elements, wherein the values correspond to one or more of the chart components; and
contextualize the extracted values from the chart components by applying the contextual data to the extracted value to obtain utility usage data.
